(19) United States
(12) Patent Application Publication
(10) Pub. No.: US 2020/0346259 A1
(43) Pub. Date: Nov. 5, 2020

(54) CLEANING DABBER FOR A BATTERY/POD SECTION OF AN ELECTRONIC VAPING DEVICE

(71) Applicant: Benjamin Neuberg, Island Park, NY (US)

(72) Inventor: Benjamin Neuberg, Island Park, NY (US)

(21) Appl. No.: 16/551,680

(22) Filed: Aug. 26, 2019

Related U.S. Application Data
(63) Continuation-in-part of application No. 29/689,925, filed on May 2, 2019.
(60) Provisional application No. 62/855,582, filed on May 31, 2019.

(51) Int. Cl. B08B 9/087; A24F 47/00; B08B 1/00; B08B 3/08

(52) U.S. Cl. CPC B08B 9/087; B08B 3/08; B08B 1/003; A24F 47/002

(57) ABSTRACT

A cleaning tool that includes a handle and an absorbent material attached to a base to a base of the handle. The handle has a stem, a release ring and a holder. The stem separates the base from the release ring. The release ring is wider than the stem and spaces apart the stem from the holder. The holder has opposite faces with concave curvature. An absorbent material is secured to an underside of the base and may be either dry or wetted with alcohol.

### CROSS-REFERENCE TO RELATED APPLICATIONS

The present application asserts the benefit of priority from U.S. provisional patent application No. 62/855,582, filed May 31, 2019 and is a continuation-in-part of U.S. design patent application Ser . No. 29/689,925 filed May 2, 2019.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE

Not applicable.

### BACKGROUND OF THE INVENTION

### Field of the Invention

The invention relates to a device suitable for cleaning oils or other residue from a battery section of an electronic vaping device.

### Discussion of Related Art

The disassembly and assembly of a conventional vaping device under the brand name JUUL is known. For instance, the online website at thepodprofessor.com provides the following information.

For the disassembly procedure, press an LED light out of the metal casing, because the primary connection point that holds the vaping device together is a plastic circle that covers the LED activation light. To allow the removal of inner components, the plastic must be pressed down into the device so that it no longer sits flush with the outer metal body. This may be accomplished by using a narrowly pointed object to press the light into the device and slightly downwards toward the charging port. While pressing the light, a blunt ended object needs to be inserted into the pod opening and firm pressure applied until the innards begin to slide out, pressing the LED plastic past the metal opening. Next, the internal assembly is pushed through the bottom of the vaping device enough to grab the exposed battery and pull it all the way out. A rubber seal near the pins at the top of the battery pops off to allow for cleaning the pins. However, the pin assembly is fragile and may be inadvertently pulled out of place if the removal is not done carefully.

Putting the vaping device back together after disassembly merely involves repeating the disassembly steps in reverse order, but without the need to push the LED out of place. The steps include reattaching the rubber seal by pressing the circular part into its hole and then positioning the top bit over the pins., insert the internal assembly and push it back into place with the LED facing the right way. A pod may be inserted for vaping.

For troubleshooting an electronic vaping device, the following is recommended at the webpage: support.juul.com/home/learn/faqs/juul-device-troubleshooting

Please try using a cotton swab dampened with a tiny bit of rubbing alcohol (squeezing off any excess first) to clean the contacts on both the pod and inside JUUL where the pod is inserted. This should restore the connection between the pod and the device if any moisture has got on them.

There may be a few tiny air bubbles down by the wicks of the JUULpod that can also contribute to the issue. Please try taking the pod out and gently tapping it (mouthpiece side up) on the table and reinserting. That should make the tiny air bubbles rise and re-saturate the wicks. You may also want to try using an alternate JUULpod to see if that helps.

For cleaning, the following is recommended at the same webpage:

We do recommend using a dry or slightly moistened cotton swab to clean the charge contacts and inside the device where the pod is inserted.

It would be desirable to provide a custom built cleaning tool that is dimensioned to effect cleaning of a battery section of a smokeless e-cigarette or other vaping device as an alternative to a cotton swab.

### SUMMARY OF THE INVENTION

One aspect of the invention resides in an alcohol dabber cleaning tool and a dry dabber cleaning tool of the present invention, which are preferably used to clean a battery of an electronic vaping device, such as the JUUL Device and USB Charging Dock that is supplied by JUUL Labs, Inc.

Another aspect resides in the manner of use of such cleaning tools. That is, place the alcohol dabber cleaning tool into the battery section of the electronic vaping device until the bottom is hit and then hold the alcohol dabber in that position for 40 seconds and then take the alcohol dabber out and discard it. Next, place the dry dabber cleaning toole into the battery section and hold the dry dabber in position for 1½ minutes and then take the dry dabber out. The battery section becomes clean as a result and ready for use.

The use of the inventive dabbers allow a person to clean the battery section of the electronic vaping device and cover all the surface area that normally would not be able to be cleaned with conventional cleaning methods. It gets into the corners and sides that are normally passed over with the conventional method.

There is an advantage to clean the electronic vaping device in this manner over the conventional manner of cleaning with a cotton swab. The cleaning with the cleaning tools of the present invention allows for a substantially cleaner drag of vapor smoke, reduces the strain on your throat, and reduces the amount of inhale strength that a person needs to do as the metal connections are fluid and clean.

### BRIEF DESCRIPTION OF THE DRAWINGS

For a better understanding of the present invention, reference is made to the following description and accompanying drawings, while the scope of the invention is set forth in the appended claims.

FIG. 1 is an isometric view of a cleaning tool in accordance with the invention, but without an absorbent material.

FIG. 2 is a top view thereof.

FIG. 3 is a front view thereof that is symmetric to the rear thereof.

FIG. 4 is a left side view thereof that is symmetric to a right side view thereof.

FIG. 5 is a bottom view thereof.

FIG. 6 is a front view of two cleaning tools thereof each having an absorbent material, with one being a dry dabber cleaning tool and the other being an alcohol dabber cleaning tool.

FIG. 7 is an isometric view of the alcohol dabber of FIG. 6 in position for insertion into an exposed battery section of a vaping device to wet clean the same.

FIG. 8 is an isometric view of the dry dabber of FIG. 6 in position for insertion into the exposed battery section of the vaping device to dry clean the same after wet cleaning with the alcohol dabber has finished.

FIG. 9 is an isometric view of a portion of the vaping device that is ready to use after cleaning is complete with the cleaning tools of FIGS. 7 and 8.

FIG. 10 is a front view of two cleaning tools as in FIG. 6, but without holes in absorbent material.

### DESCRIPTION OF THE PREFERRED EMBODIMENT

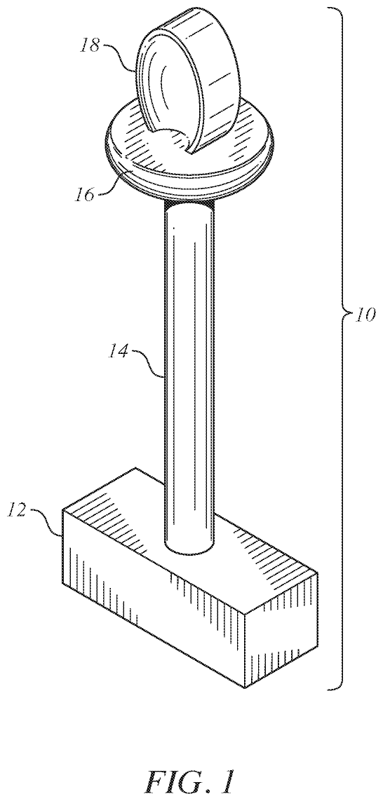

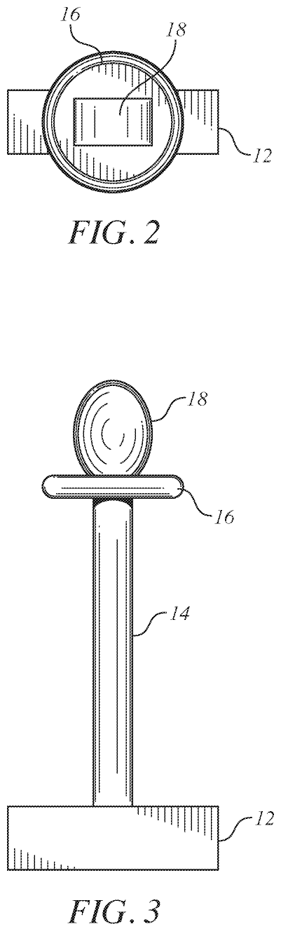

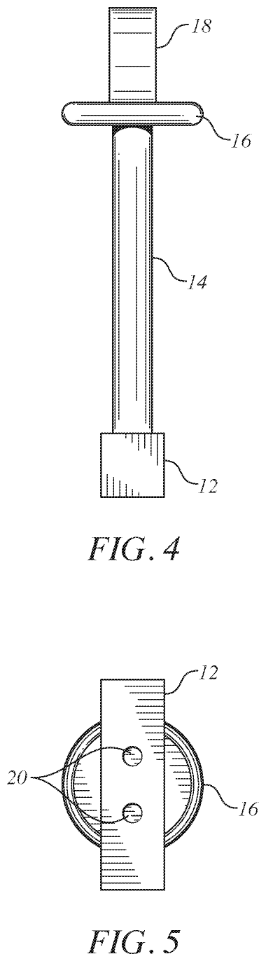

FIGS. 1-5 show a cleaning tool 10 without its absorbent material. The cleaning tool includes a base 12, a stem 14, a release ring 16 and a spoon-like holder 18. The base 12 has two spaced channels 20. The spoon-like holder 18 has opposite faces with at least one of the two faces having concave curvature. The release ring 16 has a circular periphery. The stem 14 is cylindrical in shape. The base 12 has a rectangular cross section.

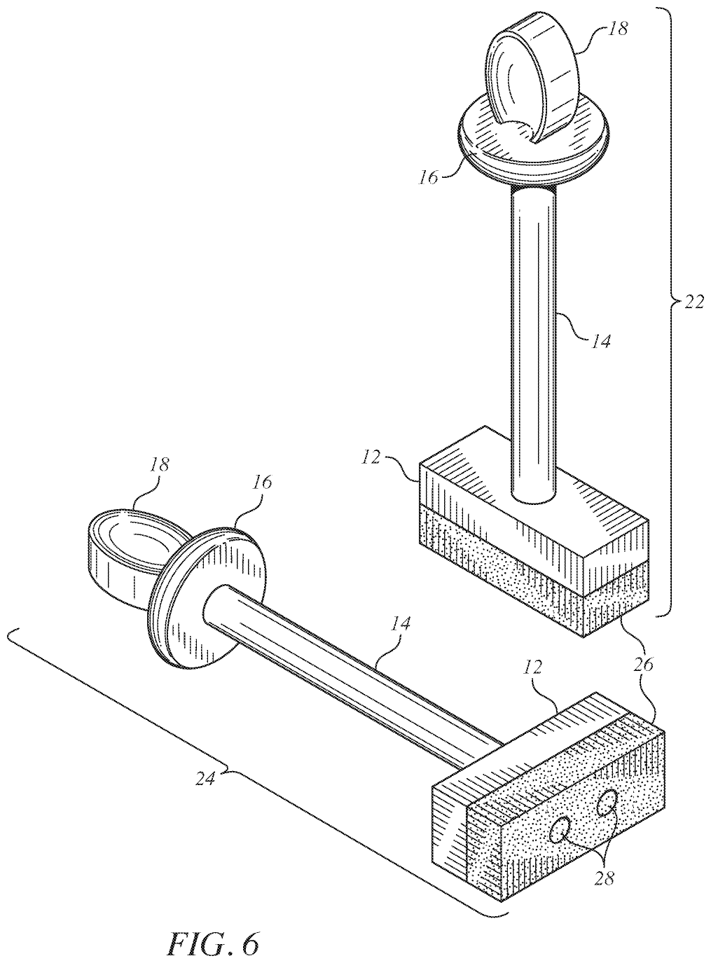

FIG. 6 depicts an alcohol dabber cleaning tool 22 and a dry dabber cleaning tool 24 each of whose base 12 is equipped with an absorbent material 26 secured to the underside of the respective base 12. The absorbent material has a rectangular cross section that matches the dimension of the base 12.

Each cleaning tool 22, 24 is configured with exact measurements to get into the spaces that oil tends to fall into, namely, the cracks between the battery shell and the inner brain attached. In contrast, a conventional Q-tip cotton swab, because of its shape, makes it hard to reach those places. The alcohol dabber cleaning tool 22 and the dry dabber cleaning tool 24 are of identical construction, except that the absorbent material 26 for the alcohol dabber cleaning tool 22 is saturated with alcohol and the absorbent material 26 for the dry dabber cleaning tool 24 is dry.

The top round part of the spoon-like holder 18 has functionality as a holder and also the release ring 16 between the stem 14 and the spoon like holder 18 aids in pulling the alcohol dabber cleaning tool 22 or dry dabber cleaning tool 24 out of the device.

Instructions for use:

Referring to FIG. 6:
Step 1—take the alcohol dabber cleaning tool and the dry dabber cleaning tool out of their common retail package (not shown) that contains them.

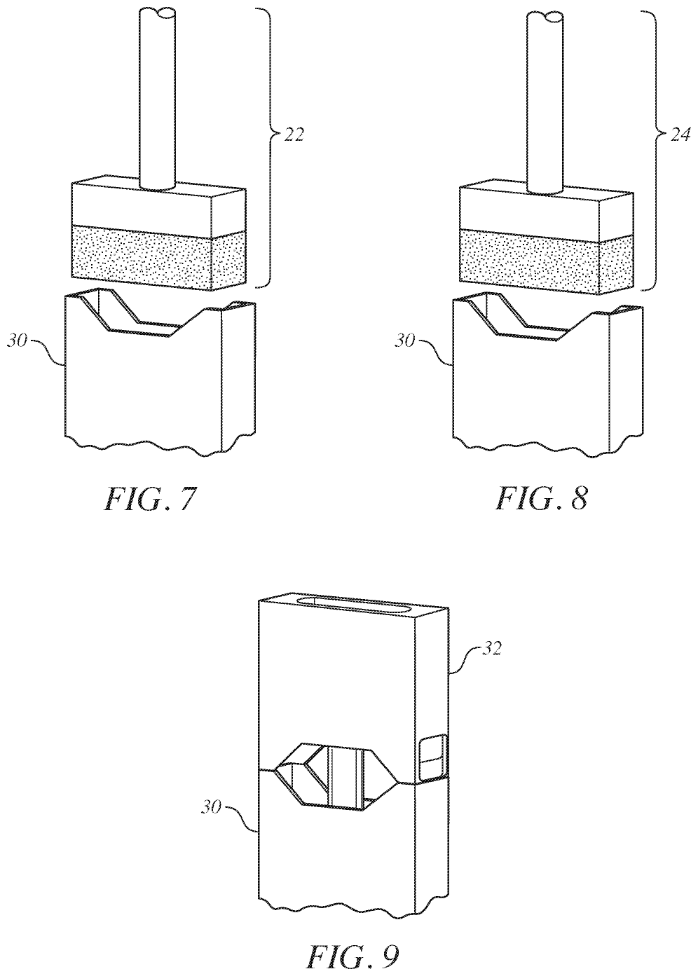

Referring to FIG. 7:
Step 2—insert the alcohol dabber cleaning tool 22 in the battery section or pod compartment 30 gently.
Step 3—move the alcohol dabber cleaning tool 22 to the right and left and up and down while in the compartment.
Step 4—remove the alcohol dabber cleaning tool 22 from the compartment, dispose of it.

Referring to FIG. 8:
Step 5—insert the dry dabber cleaning tool 24 into the battery section or pod compartment 30. Move right and left—up and down gently.
Step 6—remove the dry dabber cleaning tool 24 and dispose of it.

Referring to FIG. 9:
Step 7—place a pod 32 into the pod compartment 30 for use.

The alcohol dabber cleaning tool 22 and the dry dabber cleaning tool 24 cover the entire inner battery surface area without moving it around when each is separately inserted. Since they fit in exactly in the pod placement compartment and are dedicated to cleaning the electronic vaping device. There is no need to move it around inside. By having the ring around the handle it makes for ease to just pull the dabber out of the battery.

Preferably, the materials used are as follows. For the holder 18, release ring, 16 stem 14 and base 12, making them in one-piece construction of hard plastic, preferably molded. For the cotton part of the absorbent material for the dabber, two forms of material may be used. The alcohol dabber, which contains rubbing alcohol, is using an absorbent cotton so to hold the alcohol in place. The dry dabber contains a bounty quick absorbent material.

The holder 18, release ring 16, stem 14 and base 12 are initially molded into one-piece construction, preferably with a suitable mold form. Thereafter, two adhesive epoxies are used to place the alcohol soaked swab on the base surface area and the dry bounty style material on the base area.

The structure of the alcohol dabber cleaning tool 22 and the dry dabber cleaning tool 24 is measured to fit the battery chamber of the vaping device 30 exactly. Each has a small inverted handle (base 12, stem 14, spoon-like holder 18) with release ring 16 to make it easy to handle. Cotton, foam bottom attached with adhesive as the absorbent material 26 for dabbing, and absorbing the entire area to get the metal connections from a pod and the battery tips to be cleaner than what is attained conventionally, which does not fully clean the area.

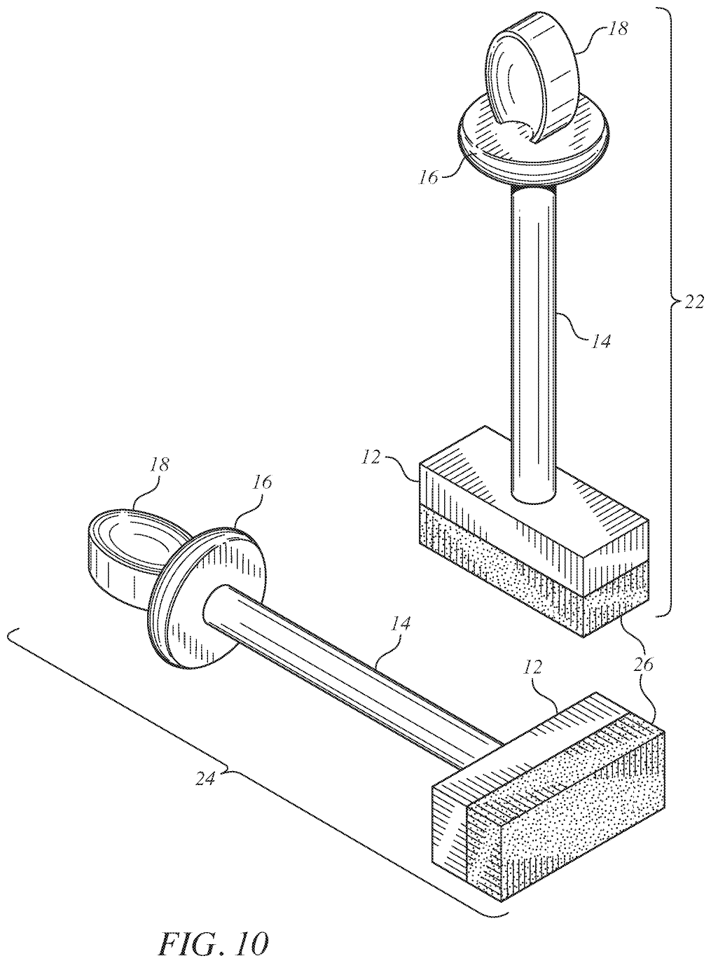

With reference to FIG. 6, the two channels 20 in the base 12 are in alignment with two channels 28 through the absorbent material 26. The channels 28, 20 accommodate insertion of respective pins that are within the battery section of the vaping device. Both the base 12 and the absorbent material 26 have pairs of parallel opposite sides that define their respective peripheries and align with each other. However, the two channels 20 in the base 12 and the two channels 28 in the base of the tool are optional and may be dispensed with entirely. For instance, the absorbent material 26 may have no through going channels at all as shown in FIG. 10 and the base of the dabber cleaning tools 22, 24 may be flat or recessed with no channels. The absorbent material 26 may envelop the pins to clean them as they are inserted into the battery section of the vaping device.

While the foregoing description and drawings represent the preferred embodiments of the present invention, various changes and modifications made be made without departing from the scope of the present invention.

What is claimed is:

1. A cleaning tool, comprising:
a handle having a holder, a release ring, a stem and a base, the release ring being wider than the stem, and separating the handle from the stem, the stem extending between the release ring and the base; and
an absorbent material secured to the base of the handle.

2. The cleaning tool of claim 1, wherein the absorbent material has two channels spaced apart that pass through the absorbent material, the base having two channels in alignment with the two channels of the absorbent material.

3. The cleaning tool of claim 1, wherein the holder has opposite faces, at least one of the opposite faces having concave curvature.

4. The cleaning tool of claim 1, wherein the absorbent material is soaked with alcohol.

5. The cleaning tool of claim 1, wherein the absorbent material is dry.

6. The cleaning tool of claim 1, wherein the release ring has a circular periphery.

7. The cleaning tool of claim 1., wherein the base and the absorbent material have respective peripheries in alignment with each other in their respective entireties.

8. The cleaning tool of claim 7, wherein each of the respective peripheries include pairs of parallel opposite sides.

9. The cleaning tool of claim 1, in combination with a pod section or battery section of a vaping device, the pod section or battery section defining an interior dimension and shape of an inner periphery that corresponds with an exterior dimension and shape of an outer periphery of the absorbent material.

10. A method of cleaning with a cleaning tool, comprising the steps of:
inserting an absorbent material within confines of a pod section or battery section of a vaping device, the absorbent material being secured to a base of a handle, the handle also having a holder, a release ring, a stem and a base, the release ring being wider than the stem and separating the handle from the stem, the stem extending between the release ring and the base, the pod section or battery section of the vaping device defining an inner periphery, the absorbent material having an exterior periphery that corresponds in dimension and shape to the inner periphery of the pod section or battery section of the vaping device.

11. The method of claim 10, further comprising the steps of;
removing the absorbent material from the confines of the pod section or battery section of the vaping device by exerting a pulling forced on the release ring, the absorbent material being soaked with alcohol; and
inserting dry absorbent material into the confines of the pod section or battery section of the vaping device, the dry absorbent material being secured to a base of a further handle, the dry absorbent material having an exterior periphery that corresponds in dimension and shape to the inner periphery of the pod section or battery section of the vaping device.

12. The method of claim 10, further comprising:
removing contents of the pod section or the battery section of the vaping device before inserting the absorbent material, wherein the contents being a pod within the pod section or a battery within the battery section.

13. The method of claim 12, further comprising the step of:
enveloping pins of the pod section or battery section within confines of the respective pair of channels in the absorbent material as a result of the step of inserting.

14. The method of claim 10, further comprising the step of:
applying pressure to opposite faces of the holder during the inserting, at least one of the opposite faces having concave curvature.
